(19) United States
(12) Patent Application Publication
(10) Pub. No.: US 2015/0326884 A1
(43) Pub. Date: Nov. 12, 2015

(54) Error Detection and Mitigation in Video Channels

(71) Applicant: Silicon Image, Inc., Sunnyvale, CA (US)

(72) Inventors: Young Don Bae, Sunnyvale, CA (US); Wooseung Yang, San Jose, CA (US); Ju Hwan Yi, Sunnyvale, CA (US); Hoon Choi, Mountain View, CA (US)

(73) Assignee: Silicon Image, Inc., Sunnyvale, CA (US)

(21) Appl. No.: 14/275,692

(22) Filed: May 12, 2014

(51) Int. Cl. H04N 19/65; H04N 19/182; H04N 19/172

(52) U.S. Cl. CPC H04N 19/65; H04N 19/172; H04N 19/182

(57) ABSTRACT

A system for detecting and mitigating bit errors in transmitted media is described herein. A source device encodes a frame of video, and generates an error code representative of a portion of the encoded frame of video. The portion of encoded frame and the error code are provided to a sink device via a communication channel, such as an HDMI or MHL3 channel. A second error code is generated by the sink device based on the portion of encoded frame, and the error code and second error code are compared to determine if the portion of encoded frame includes an error. If no error is detected, the portion of encoded frame is decoded and outputted. If an error is detected, the portion is replaced with frame data based on at least one other portion of encoded frame to produce a mitigated frame, and the mitigated frame is outputted.

### FIELD

Embodiments of the invention generally relate to the field of networks and, more particularly, to error detection and mitigation within video channels.

### BACKGROUND

The transmittal of video data over a video channel in modern digital video interface systems is generally subject to some non-zero bit error rate. Often the bit error rate is on the order of 10⁻⁹. For high-resolution data, such as 4 k video (3840 pixels by 2160 pixels) and higher, at such a bit error rate, bit errors can occur every few seconds or less. The frequency of bit errors increases as video resolution and frame rate increase. The problem of bit errors is exacerbated by video compression techniques that rely on the values of surrounding pixels. In such compression schemes, one incorrect pixel value caused by a bit error can result in entire sets, lines, or frames of pixels being lost. The increase in occurrence of such errors in increasingly high definition video environments can result in unpleasant experiences for users of such video environments.

### SUMMARY

A system for detecting and mitigating bit errors in transmitted media is described herein. A source device encodes a frame of video, and generates an error code representative of a portion of the encoded frame of video. An example of a generated error code is a CRC code. The portion of encoded frame and the error code are combined into a data stream, and output via a communication channel, such as an HDMI channel or MHL3 channel.

A sink device receives the data stream, and parses the data stream to generate the portion of encoded frame and the error code. A second error code is generated based on the portion of encoded frame. The error code and second error code are compared to determine if the portion of encoded frame includes an error. If no error is detected, the portion of encoded frame is decoded, buffered, and combined with other portions of the encoded frame to form a decoded frame. If an error is detected, the portion is replaced with frame data based on at least one other portion of encoded frame, such as adjacent lines of pixels, to produce a mitigated frame. The decoded frame or the mitigated frame is then outputted, for instance for storage or display. In some embodiments, if the portion of encoded frame includes an error, the sink device can request retransmission of the portion from the source device.

### BRIEF DESCRIPTION OF THE DRAWINGS

Embodiments of the invention are illustrated by way of example, and not by way of limitation, in the figures of the accompanying drawings in which like reference numerals refer to similar elements:

FIG. 1 is a block diagram illustrating a video interface environment, according to one embodiment.

FIG. 2 is a block diagram illustrating a video interface environment with source-side and sink-side error detection and mitigation, according to one embodiment.

FIG. 3 is a block diagram illustrating a video interface environment with sink-side error detection and mitigation, according to one embodiment.

FIG. 4 is a timing diagram illustrating error detection and mitigation data signals in a video interface environment, according to one embodiment.

FIG. 5 is a block diagram illustrating a retransmission feedback loop in a video interface environment with source-side and sink-side error detection and mitigation, according to one embodiment.

FIG. 6 is a flow chart illustrating a process for detecting and mitigating errors in a video interface environment, according to one embodiment.

### DETAILED DESCRIPTION

As used herein, “network” or “communication network” mean an interconnection network to deliver digital media content (including music, audio/video, gaming, photos, and others) between devices using any number of technologies, such as SATA, Frame Information Structure (FIS), etc. An entertainment network may include a personal entertainment network, such as a network in a household, a network in a business setting, or any other network of devices and/or components. A network includes a Local Area Network (LAN), Wide Area Network (WAN), Metropolitan Area Network (MAN), intranet, the Internet, etc. In a network, certain network devices may be a source of media content, such as a digital television tuner, cable set-top box, handheld device (e.g., personal device assistant (PDA)), video storage server, and other source device. Such devices are referred to herein as “source devices” or “transmitting devices”. Other devices may receive, display, use, or store media content, such as a digital television, home theater system, audio system, gaming system, video and audio storage server, and the like. Such devices are referred to herein as “sink devices” or “receiving devices”. As used herein, a “video interface environment” refers to an environment including a source device and a sink device coupled by a video channel. One example of a video interface environment is a High-Definition Content Protection (HDCP) environment, in which a source device (such as a DVD player) is configured to provide media content encoded according to the HDCP protocol over an HDMI channel or a MHL3 channel to a sink device (such as television or other display).

It should be noted that certain devices may perform multiple media functions, such as a cable set-top box that can serve as a receiver (receiving information from a cable head-end) as well as a transmitter (transmitting information to a TV) and vice versa. In some embodiments, the source and sink devices may be co-located on a single local area network. In other embodiments, the devices may span multiple network segments, such as through tunneling between local area networks. It should be noted that although error detection and mitigation is described herein in the context of a video interface environment, the error detection and mitigation protocols described herein are applicable to any type of data transfer between a source device and a sink device, such as the transfer of audio data in an audio environment, network data in a networking environment, and the like.

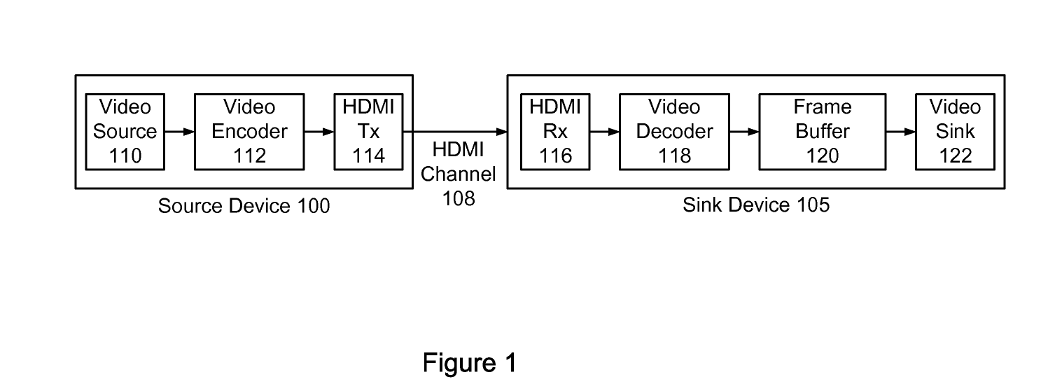

FIG. 1 is a block diagram illustrating a video interface environment, according to one embodiment. The environment of FIG. 1 includes a source device 100 coupled to a sink device 105 by an HDMI channel 108. The source device 100 includes a video source 110, a video encoder 112, and an HDMI transmitter 114. The sink device 105 includes an HDMI receiver 116, a video decoder 118, a frame buffer 120, and a video sink 122. It should be noted that in other embodiments, the environment of FIG. 1 can include different and/or additional components than those illustrated herein. For example, instead of an HDMI transmitter 114 and HDMI receiver 116 communicating over an HDMI channel 108, the environment of FIG. 1 can include a transmitter and receiver configured to communicate over any suitable type of media or communications channel, such as an MHL3 channel, another serial-type channel, or any other suitable type of channel.

The video source 110 can be a non-transitory computer-readable storage medium, such as a memory, configured to store one or more videos for transmitting to the sink device 105. The video source 110 can also be configured to access video stored external to the source device 100, for instance from an external video server communicatively coupled to the source device by the internet or some other type of network. The video encoder 112 is configured to encode video from the video source 110 prior to transmission by the HDMI transmitter 114. The video encoder 112 can implement any suitable type of encoding, for instance encoding intended to reduce the quantity of video data being transmitted (such as H.264 encoding and the like), encoding intended to secure the video data from illicit copying or interception (such as HDCP encoding and the like), or any combination of the two. The HDMI transmitter 114 is configured to transmit the encoded video data according to the HDMI protocol over the HDMI channel 105 to the HDMI receiver 116.

The HDMI receiver 116 is configured to receive encoded video from the HDMI transmitter 114 via the HDMI channel 108. The video decoder 118 is configured to decode the encoded video received by the HDMI receiver 116. The frame buffer 120 is a memory or other storage medium configured to buffer partial or entire frames of vided decoded by the video decoder 118. In some embodiments, the video sink 122 is configured to display frames of video buffered by the frame buffer 120. Alternatively, the video sink 122 can store the video frames received from the frame buffer 120, or can output the video frames to (for example) an external display, storage, or device (such as a mobile device).

In the embodiment of FIG. 1, errors can occur during the transfer of encoded video data between the HDMI transmitter 114 and the HDMI receiver 116. For instance, the values of bits of data can be warped within the HDMI channel 108 during data transfer, the HDMI receiver 116 can fail to receive certain transferred bits, and the like. Such errors are referred to collectively herein as “bit errors” or simply “errors”. As decoding bits of video often relies on the accuracy of surrounding bits, when the video decoder 118 attempts to decode received encoded video data including one or more bit errors, the resulting decoded video can include various video artifacts, affecting regions of frames, lines of pixels, or entire frames.

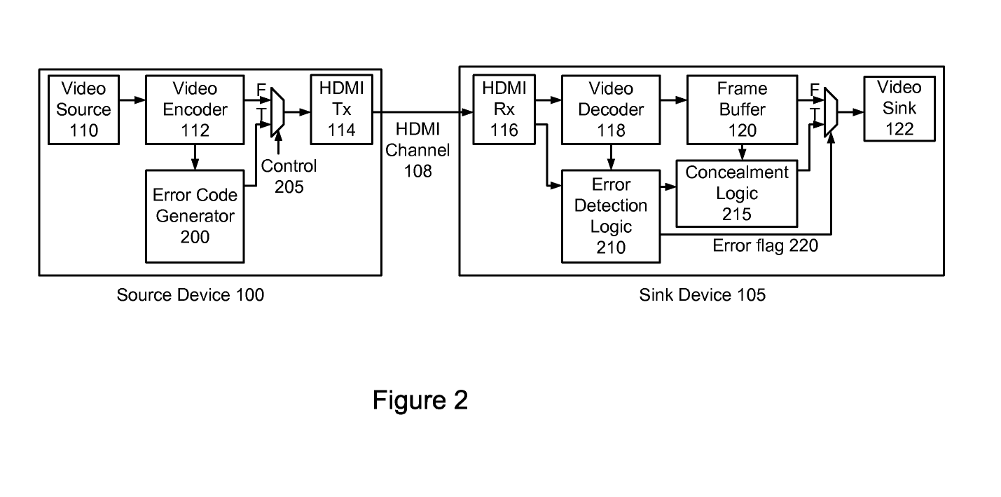

FIG. 2 is a block diagram illustrating a video interface environment with source-side and sink-side error detection and mitigation, according to one embodiment. In the embodiment of FIG. 2, the source device 100 includes an error code generator 200. The error code generator receives a portion of encoded video data from the video encoder 112, and generates an error code based on the portion of encoded video data. The portion of encoded video data can be one pixel, a set of pixels, a line of pixels, multiple lines of pixels, a portion of or a full frame, or any other suitable portion of encoded video data. The error code can be based on a value of the portion of the encoded video data, based on properties of the portion of the encoded video data, based on pixel values of pixels in the portion of the encoded video data, and the like. In one embodiment, the error code generated by the error code generator 200 is a cyclic redundancy check (“CRC” code), though in other embodiments, any suitable hash function or redundancy algorithm can be performed.

The error code generated by the error code generator 200 is added to the video data portion encoded by the video encoder 112 using a multiplexor (controlled by the control signal 205) prior to being outputted by the HDMI transmitter 114. The combination of the encoded video data portion and the error code is referred to herein as the “combined encoded data”. In some embodiments, the encoded video data is output one encoded frame at a time, with each encoded frame including image data portions and non-image data portions. The non-image data portions of a frame can include frame meta data describing characteristics of the encoded frame (such as a number of pixels in the frame, frame dimensions, a total amount of frame data, a frame index or identity, and the like), characteristics of the encoding used to encode the frame (such as the type of algorithm used to encode the frame, encryption keys, and the like), or any other suitable aspect of the frame. The non-image portions of a frame are referred to herein as “blanking intervals”.

In some embodiments, the HDMI transmitter 114 outputs encoded frame data one encoded frame line at a time, with each outputted encoded frame line including an image data portion and a blanking interval portion. In some embodiments, the error code generated by the error code generator 200 is included within an outputted blanking interval. For example, if the HDMI transmitter outputs encoded frame data one encoded frame line at a time, the control signal 205 can configure a multiplexor to output the image data portion of an encoded frame line, and can configure the multiplexor to output the generated error code within the blanking interval portion of an encoded frame line.

Upon receiving the combined encoded data, the HDMI receiver 116 parses the combined encoded data and provides the encoded video data portion to the video decoder 118 and the error code to the error detection logic 210. The video decoder 118 generates a second error code based on the encoded video data portion using the same error code algorithm or function as the error code generator 200. The video decode 118 also decodes the encoded video data portion, and provides the decoded video data portion to the frame buffer 120, which is configured to buffer one or more video data portions (for instance, video data portions making up one or more entire frames).

The error detection logic 210 compares the error code received from the HDMI transmitter 116 and the second error code from the video decoder 118, and determines whether or not a bit error is present in the received encoded video data portion based on the comparison. For example, if the error code and the second error code are not identical, the error detection logic 210 determines that a bit error is present in the encoded video data portion. The error detection logic 210 provides an indication of the error determination for the encoded video data portion to the concealment logic 215, and provides an error flag 220 for use as a control signal for a multiplexor coupled to the frame buffer 120 and the concealment logic 215.

If the error detection logic 210 does not detect an error in the encoded video data portion for each portion of a video frame, the error flag 220 is held low, and the multiplexor is configured to output the video frame (stored by the frame buffer 120) to the video sink 122. If the error detection logic 210 does detect an error in an encoded video data portion within a video frame, the concealment logic 215 accesses video frame data associated with the video frame from the frame buffer 120, and replaces the video data portion that includes the bit error using the accessed video frame data. For instance, if the video data portion that includes the bit error is a line of pixels, the concealment logic 215 can access the line of pixels on either side of the line of pixels including the error, can determine the average the pixel values for the two accessed lines of pixels, and can replace the line of pixels including the error with the determined average of the two accessed line of pixels to produce a mitigated video frame. The concealment logic 215 then outputs the mitigated video frame to the multiplexor. In such instances, the error flag 220 is held high, and the multiplexor is configured to output the mitigated video frame to the video sink 122. It should be noted that in other embodiments, any other suitable type of error mitigation can be implemented by the concealment logic 215. For example, a portion of video data including an error can be replaced by a portion located in the same location in a previous frame buffered by the frame buffer 120.

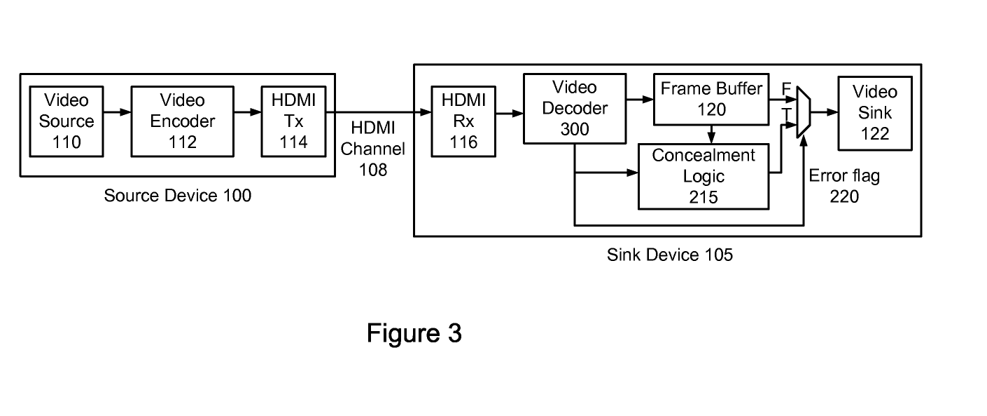

In some embodiments, a source device 100 is not equipped to enable error code detection. In such embodiments, sink-side error detection and mitigation can be implemented. FIG. 3 is a block diagram illustrating a video interface environment with sink-side error detection and mitigation, according to one embodiment. In the embodiment of FIG. 3, a source device 100 (such as the source device 100 of the embodiment of FIG. 1) is coupled to a sink device 105 via an HDMI channel 108. The source device 100 transmits an encoded video data portion (such as a line of pixels in a video frame) to the sink device 105. The HDMI receiver 116 receives the encoded video data portion and provides the received encoded video data portion to the video decoder 300.

The video decoder 300 is configured to analyze the encoded video data portion to determine if the encoded video data portion includes bit errors. In one embodiment, the video decoder 300 identifies errors in the encoded video data portion in response to a determination that a header for the video data portion is in an invalid header format. For example, a bit error in an encoded video data portion with a proper header can change the format of the header into an improper format. In one embodiment, the video decoder 300 identifies errors in the encoded video data in response to a determination that the length of one or more portions of the encoded video data portion is an invalid length. For example, a bit error in an encoded video data portion defined to include 32 bits of pixel data can cause the encoded video data portion to be 31 or 33 bits in length. In other embodiments, the video decoder 300 can determine that the encoded video data portion includes bit errors using any other suitable technique.

In response to determining that the encoded video data portion includes a bit error, the video decoder 300 provides an indication of the error to the concealment logic 215, and outputs an error flag 220. As described above, if no error is detected, the error flag 220 is held low, and a multiplexor is configured to output the frame including the encoded video data portion from the frame buffer 120 to the video sink 122. If an error is detected, the concealment logic 215 accesses the frame data stored in the frame buffer 120 and mitigates the error by replacing the portion of encoded video data including the error with a replacement portion determined based on accessed frame data to produce a mitigated video frame. In addition, the error flag 220 is held high, configuring the multiplexor to output the mitigated video frame from the concealment logic 215 to the video sink 122.

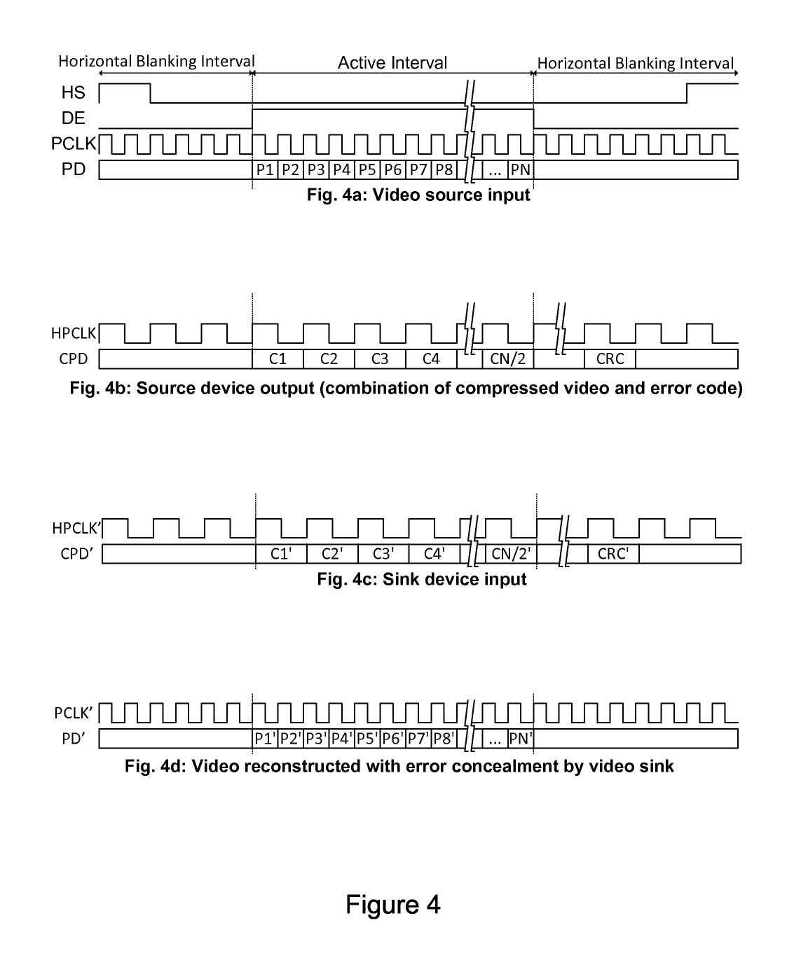

FIG. 4 is a timing diagram illustrating error detection and mitigation data signals in a video interface environment, according to one embodiment. FIG. 4a illustrates a video source input timing diagram, including an active interval between two blanking intervals. During the active interval, a portion of video data (pixels P₁ through P_{N}) is outputted from a video source to a video encoder. During the blanking interval, no video data is outputted.

FIG. 4b is a timing diagram illustrating the output of a source device configured to encode the video data portion of FIG. 4a, to generate an error code, and to output the encoded video data portion and the error code. The encoded video data portion includes combined pixels C₁ through C_{N/2} (each combined pixel representative of a combination of two pixels of video data) outputted during the active interval. In addition, the determined CRC error code is outputted during the blanking interval following the active interval. FIG. 4c is a timing diagram that illustrates the encoded data (C₁′ through C_{N/2}′) and the error code CRC′ received by a sink device from the source device, and FIG. 4d is a timing diagram that illustrates the decoded video data, pixels P₁′ through P_{N}′.

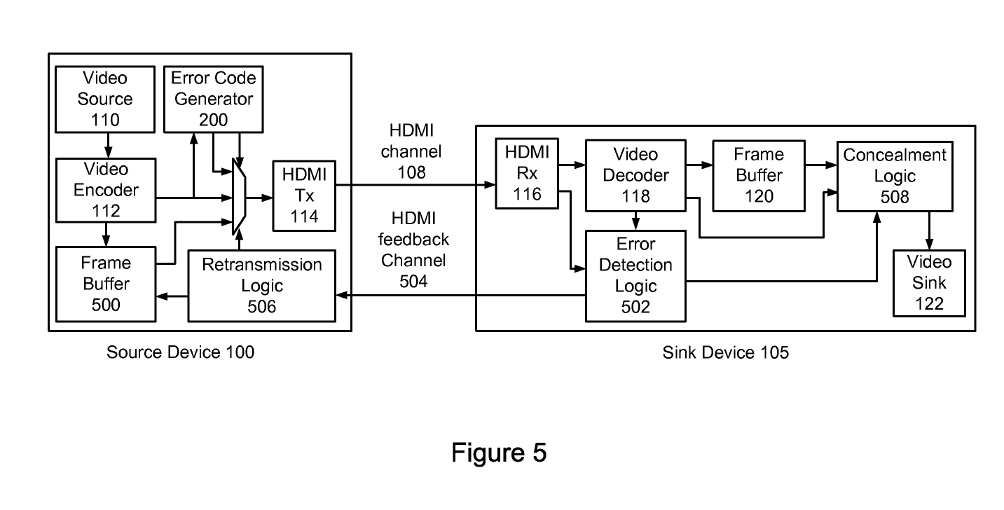

In some embodiments, instead of mitigating video data portions that include bit errors, a sink device can request that the source device re-send the video portion determined to include an error. FIG. 5 is a block diagram illustrating a retransmission feedback loop in a video interface environment with source-side and sink-side error detection and mitigation, according to one embodiment. In the embodiment of FIG. 5, a source device 100 includes a video encoder 112 configured to encode video from a video source 110. The video encoder 112 provides encoded video data to a frame buffer 500 for temporary storage, to an error code generator 200 for generating an error code based on the encoded video data, and to a multiplexor configured to output the encoded video data and the generated error code to an HDMI transmitter 114 for transmission over an HDMI channel 108 to a sink device 105. The frame buffer 500 can buffer one or more frames for a pre-determined interval of time, for a pre-determined number of frame encoding operations performed by the video encoder 112, or based on any other suitable criteria. Similar to the error code generator 200 of FIG. 2, the error code generator 200 of FIG. 5 generates an error code (such as a CRC code) based on the encoded video data, provides the generated error code to the multiplexor, and provides a control signal to the multiplexor to configure the multiplexor to output the error code to the sink device 105 in combination with the encoded video data.

An HDMI receiver 116 receives and parses the combined encoded video data and error code, providing the encoded video data to a video decoder 118 and providing the error code to an error detection logic 502. The video decoder 118 generates a second error code based on the encoded video data and provides the second error code to the error detection logic 502. The video decoder 118 also decodes the encoded video data, and provides the decoded video data to a frame buffer 120 for buffering in the event of a detected error. The error detection logic 502 compares the error code and the second error code, and determines if the encoded video data includes an error based on the comparison. In response to a determination that the encoded video data does include an error, the error detection logic 502 sends a request for retransmission of the encoded video data from the source device 100 via the HDMI feedback channel 504. In some embodiments, the request is for retransmission of a portion of a frame (such as a set of pixels or a line of pixels), or for an entire frame.

The retransmission logic 506 requests the requested encoded video data from the frame buffer 500, and provides a control signal to configure the multiplexor to output the requested encoded video data from the frame buffer 500 to the HDMI transmitter 114 for retransmission to the sink device 105. Upon receiving the retransmitted encoded video data, the HDMI receiver 116 provides the retransmitted encoded video data to the video decoder 118. The video decoder 118 decodes the retransmitted encoded video data, and provides the decoded transmitted video data to the concealment logic 508. In embodiments in which the retransmitted video data comprises a portion of a frame, the concealment logic 508 accesses the remainder of the frame from the frame buffer 120, combines the remainder of the frame and the retransmitted frame portion to form a combined frame, and provides the combined frame to the video sink 122.

It should be noted that in embodiments in which the error detection logic 502 does not detect an error in an entire frame of received encoded video data, the error detection logic can configure the concealment logic 508 to output the frame from the frame buffer 120 to the video sink 122 without requesting retransmission of any encoded video data. It should also be noted that in some embodiments, retransmitted encoded video data can be checked for errors prior to outputting the retransmitted video data to the concealment logic 508. For instance, the error code generator 200 can generate an error code for the requested video data, the video decoder 118 can generate a second error code based on the retransmitted encoded video data, and the error detection logic 502 can compare the error code and the second error code to determine if the retransmitted video data includes an error. If an error is found in the retransmitted video data, the error detection logic 502 can again request retransmission of the encoded video data, or can configure the concealment logic 508 to mitigate the error using other techniques (such as those described herein).

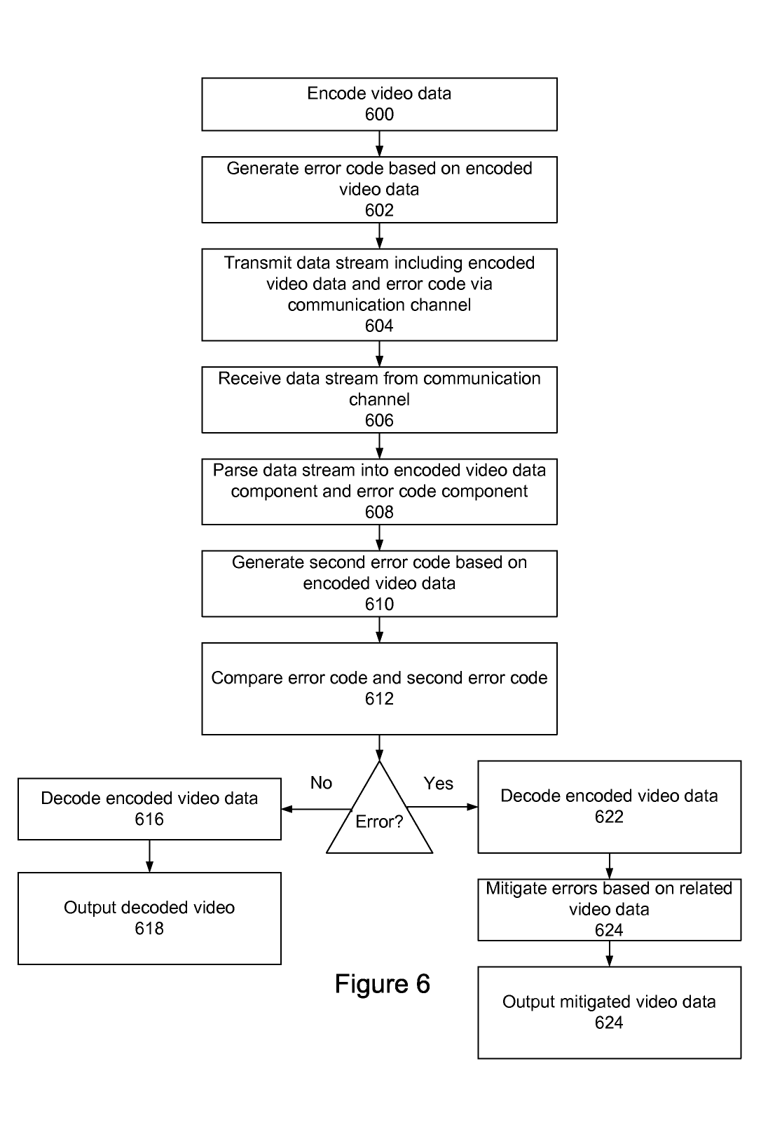

FIG. 6 is a flow chart illustrating a process for detecting and mitigating errors in a video interface environment, according to one embodiment. Video data is encoded 600 by a source device, and an error code is generated 602 based on the encoded video data. A data stream including the encoded video data and the error code is transmitted 604 by the source device via a communications channel (such as an HDMI channel, an MHL3 channel, or any other suitable channel). The data stream is received 606 from the communication channel by a sink device.

The sink device parses 608 the data stream into the encoded video data and the error code. A second error code is generated based on the received encoded video data. The error code and the second error code are compared 612 to determine if an error is present in the encoded video data. If an error is not present, the encoded video is decoded 616, and outputted 618 by the sink device. If an error is present, the encoded video data is decoded 622, and the error is mitigated 624 based on video data related to the decoded video data. For instance, if one line of pixels contains an error, the lines above and below the line of pixels can be averaged, and the line of pixels can be replaced by the determined average. The mitigated video data is then outputted 624 by the sink device.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof. One of ordinary skill in the art will understand that the hardware, implementing the described modules, includes at least one processor and a memory, the memory comprising instructions to execute the described functionality of the modules.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based herein. Accordingly, the disclosure of the embodiments is intended to be illustrative, but not limiting.

What is claimed is:

1. A method comprising:
encoding, by the source device, a frame of video;
generating, by the source device, an error code representative of a portion of the encoded frame;
providing, by the source device to a sink device, the portion of the encoded frame and the error code via a communication channel;
generating, by the sink device, a second error code based on the provided portion of the encoded frame;
determining if the provided portion of the encoded frame includes an error based on a comparison of the error code and the second error code;
responsive to a determination that the portion of the encoded frame does not include an error, decoding the portion of the encoded frame; and
responsive to a determination that the portion of the encoded frame does include an error, replacing the portion of the encoded frame based on at least one other portion of the encoded frame.

2. The method of claim 1, wherein the error code and second error code comprise Cyclic Redundancy Check (CRC) codes.

3. The method of claim 1, wherein the communication channel comprises a High-Definition Multimedia Interface (HDMI) channel.

4. The method of claim 1, wherein the communication channel comprises a Mobile High Definition Link (MHL) channel.

5. The method of claim 1, wherein the portion of the encoded frame comprises a line of pixels within the frame.

6. The method of claim 1, wherein replacing the portion of the encoded frame comprises determining the average of two lines of pixels within the frame adjacent to the line of pixels within the frame, and replacing the line of pixels within the frame with the determined average.

7. The method of claim 1, wherein the error code is included within a blanking interval associated with the portion of the encoded frame prior to providing the portion of the encoded frame and the error code via the communication channel.

8. An apparatus comprising:
a receiver configured to receive, from a source device via a communication channel, a portion of an encoded frame and an error code representative of the portion of the encoded frame;
a decoder configured to generate a second error code based on the portion of the encoded frame and to decode the portion of the encoded frame;
error detection logic configured to determine if the portion of the encoded frame includes an error based on a comparison of the error code and the second error code;
concealment logic configured to replace the portion of the encoded frame based on at least one other portion of the encoded frame to form a mitigated frame in response to an error detected within the portion of the encoded frame; and
an output configured to output the decoded frame or the mitigated frame.

9. The apparatus of claim 8, wherein the error code and second error code comprise Cyclic Redundancy Check (CRC) codes.

10. The apparatus of claim 8, wherein the communication channel comprises a High-Definition Multimedia Interface (HDMI) channel.

11. The apparatus of claim 8, wherein the communication channel comprises a Mobile High Definition Link (MHL) channel.

12. The apparatus of claim 8, wherein the portion of the encoded frame comprises a line of pixels within the frame.

13. The apparatus of claim 8, wherein the error code is included within a blanking interval associated with the portion of the encoded frame prior.

14. The apparatus of claim 8, wherein the error detection logic is further configured to request a re-transmission of the portion of the encoded frame in response to an error detected within the portion of the encoded frame.

15. A method comprising:
receiving, from a source device via a communication channel, a portion of an encoded frame and an error code representative of the portion of the encoded frame;
generating a second error code based on the portion of the encoded frame and to decode the portion of the encoded frame;
determining if the portion of the encoded frame includes an error based on a comparison of the error code and the second error code;
replacing the portion of the encoded frame based on at least one other portion of the encoded frame to form a mitigated frame in response to an error detected within the portion of the encoded frame; and
outputting the decoded frame or the mitigated frame.

16. The method of claim 15, wherein the error code and second error code comprise Cyclic Redundancy Check (CRC) codes.

17. The method of claim 15, wherein the communication channel comprises a High-Definition Multimedia Interface (HDMI) channel.

18. The method of claim 15, wherein the communication channel comprises a Mobile High Definition Link (MHL) channel.

19. The method of claim 15, wherein the portion of the encoded frame comprises a line of pixels within the frame.

20. The method of claim 15, wherein the error code is included within a blanking interval associated with the portion of the encoded frame prior.

21. The method of claim 15, further comprising requesting re-transmission of the portion of the encoded frame in response to an error detected within the portion of the encoded frame.
